(19) United States
(12) Patent Application Publication
(10) Pub. No.: US 2006/0069931 A1
(43) Pub. Date: Mar. 30, 2006

(54) Method and apparatus for managing power in portable information device

(75) Inventors: Sang-hyun Shin, Suwon-si (KR); Se-an Kwon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/219,693

(22) Filed: Sep. 7, 2005

(30) Foreign Application Priority Data
Sep. 30, 2004 (KR) 10-2004-77726

(51) Int. Cl. G06F 1/26

(52) U.S. Cl. 713/300

(57) ABSTRACT

A method and apparatus for managing power in a portable information device. The method includes entering a low power consumption state if power of the device drops below a first threshold; and backing up data stored in an internal memory of the device through a network if the power of the device drops below a second threshold that is lower than the first threshold.

### CROSS REFERENCE TO RELATED APPLICATION

This application claims the priority of Korean Patent Application No. 10-2004-0077726, filed on Sep. 30, 2004, in the Korean Intellectual Property Office, the disclosure of which is incorporated herein in its entirety by reference.

### BACKGROUND OF THE INVENTION

1. Field of the Invention

The present invention relates to a method and apparatus for managing power in a portable information device, in order to preserve data safely.

2. Description of the Related Art

Portable electronic devices capable of storing information (hereinafter referred to as portable information devices), such as mobile computers, enable users to work while on the move. While users can periodically save their work to a storage medium, in between saves their work is generally stored in RAM and can be lost if the portable device's battery suddenly runs out.

FIG. 1 is a diagram illustrating power states of a conventional portable information device.

Referring to FIG. 1, the portable information device is initially in a power-off state 110. When a user turns the power on in step 120, the device goes into a normal operating state 130. In the normal operating state 130, the user can use the device for communication, data manipulation, word processing, etc.

If the voltage generated by a battery of the device falls below a certain threshold value, the device goes into a suspended state 140 (sleep mode) in which a CPU clock speed is reduced and processes performed by a CPU are minimized, in order to reduce power consumption.

In the suspended state 140, unless the battery is recharged, voltage of the battery continues to drop until the suspended state 140 can no longer be maintained, at which time the device returns to the power-off state 110. Here, if the battery is not recharged and the device returns to the power-off state 110, all user data stored temporarily in an internal memory of the device may be lost.

FIG. 2 is a schematic block diagram illustrating a conventional apparatus for managing power in the portable information device.

Referring to FIG. 2, the apparatus includes a complex programmable logic device (CPLD) 210 that detects battery voltage and generates an interrupt signal, and a CPU 220 that puts the portable information device into the suspended state 140 in response to the interrupt signal.

The CPLD 210 is coupled with a first 3.5V detector 213 that detects if the voltage of an armored battery 211 drops below 3.5V, a second 3.5V detector 214 that detects if the voltage of a built-in battery 212 drops below 3.5V, a DC detector 215 that detects DC voltage, and a detection switch 216 that detects whether the armored battery 211 is loaded.

The CPLD 210 is also coupled with a general purpose input/output (GPIO) of the CPU 220 in order to inform the CPU 220 via the interrupt signal when the voltages of either the armored battery 211 or the built-in battery 212 drop below 3.5V and allow the CPU 220 to go into the suspended state 140.

The CPU 220 sets the state of the portable information device to the suspended state 140 when it receives the interrupt signal from the CPLD 210 via the GPIO. In the suspended state 140, a clock speed of the CPU 220 is lowered and I/O devices including an LCD are rendered inactive.

Once in the suspended state 140, if the battery is not recharged and the portable information device returns to the power-off state 110, all user data stored temporarily in an internal memory of the device may be lost.

### SUMMARY OF THE INVENTION

Additional aspects and/or advantages of the invention will be set forth in part in the description which follows and, in part, will be apparent from the description, or may be learned by practice of the invention.

The present invention provides a method and apparatus for managing power in a portable information device, which prevents loss of user data by backing up data stored in an internal memory when battery voltage drops below a low power consumption state voltage.

According to an aspect of the present invention, there is provided a method of managing power in a portable information device, the method including: entering a low power consumption state if power of the device drops below a first threshold; and backing up data stored in an internal memory of the device through a network if the power of the device drops below a second threshold that is lower than the first threshold.

According to an aspect of the present invention, the method further includes re-entering the low power consumption state after the backup.

According to an aspect of the present invention, the method further includes backing up data stored in the internal memory of the device into an external memory.

According to another aspect of the present invention, there is provided an apparatus for managing power in a portable information device, the apparatus including: a backup processor that launches the device into a low power consumption state if power of the device drops below a first threshold, and backs up data stored in an internal memory of the device through a network if the power of the device drops below a second threshold that is less than the first threshold.

According to an aspect of the present invention, the backup processor launches the device back into the low power consumption state after the backup.

According to an aspect of the present invention, the backup processor backs up the data stored in the internal memory into an external memory.

### BRIEF DESCRIPTION OF THE DRAWINGS

The above and other aspects and advantages of the present invention will become more apparent by describing in detail embodiments thereof with reference to the attached drawings in which:

FIG. 1 is a diagram illustrating power states of a conventional portable information device;

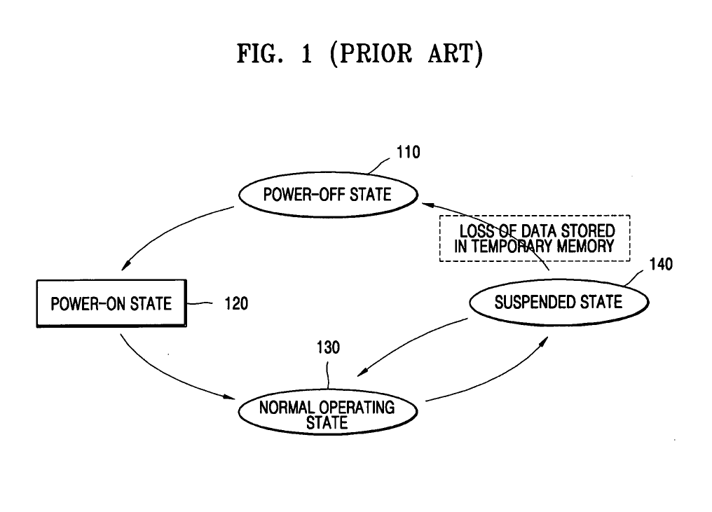

FIG. 2 is a schematic block diagram of an apparatus for managing power in a conventional portable information device;

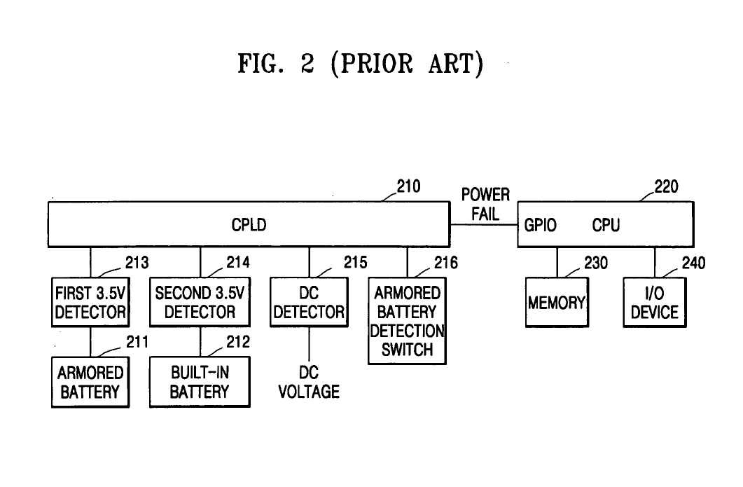

FIG. 3 is a diagram illustrating states of a portable information device according to the present invention;

FIG. 4 is a block diagram illustrating an apparatus for managing power in a portable information device, according to the present invention; and

FIG. 5 is a flowchart illustrating a method of managing power in a portable information device.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

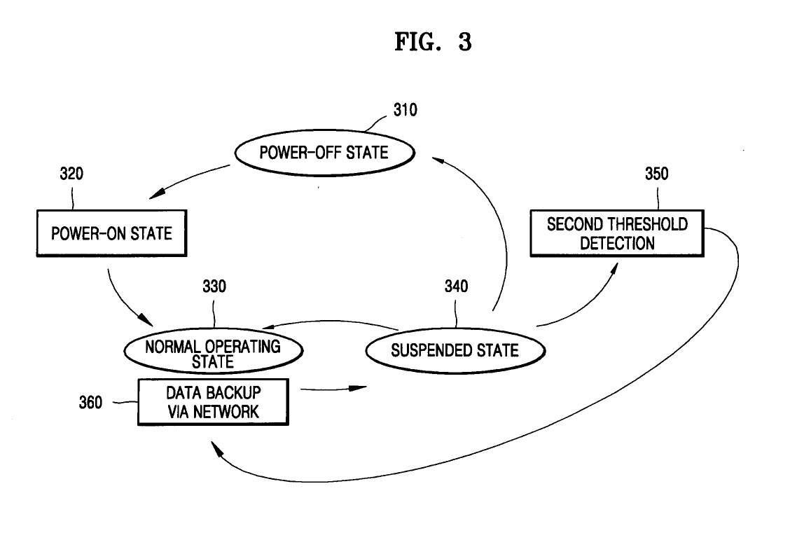

FIG. 3 is a state diagram illustrating power states of a portable information device according to the present invention.

Referring to FIG. 3, the device goes from a power-off state 310 into a power-on state when a user turns power on in step 320. Then, the device goes into a normal operating state 330. In the normal operating state 330, the device operates normally and can be used for communicating, data manipulation, word processing, etc.

If the power of the device drops below a first threshold, the device enters a suspended state 340 in which a CPU clock speed is reduced and processes performed by a CPU are minimized, in order to reduce power consumption. In the suspended state 340, CPU wakeup can occur, i.e., the device can go back into the normal operating state 330, if manipulated by the user.

In the suspended state 340, if the voltage of the device drops below a second threshold 350, which is lower than the first threshold, the CPU wakes up, and the device returns to the normal operating state 330 to backup data in an internal memory. Here, the data is backed up by uploading it to a designated server via a network. Then, the device returns to the suspended state 340.

In this way, if the device's power drops to the lowest level possible to sustain the suspended state 340, data stored in the internal memory is backed up via the network, so that user data is not lost.

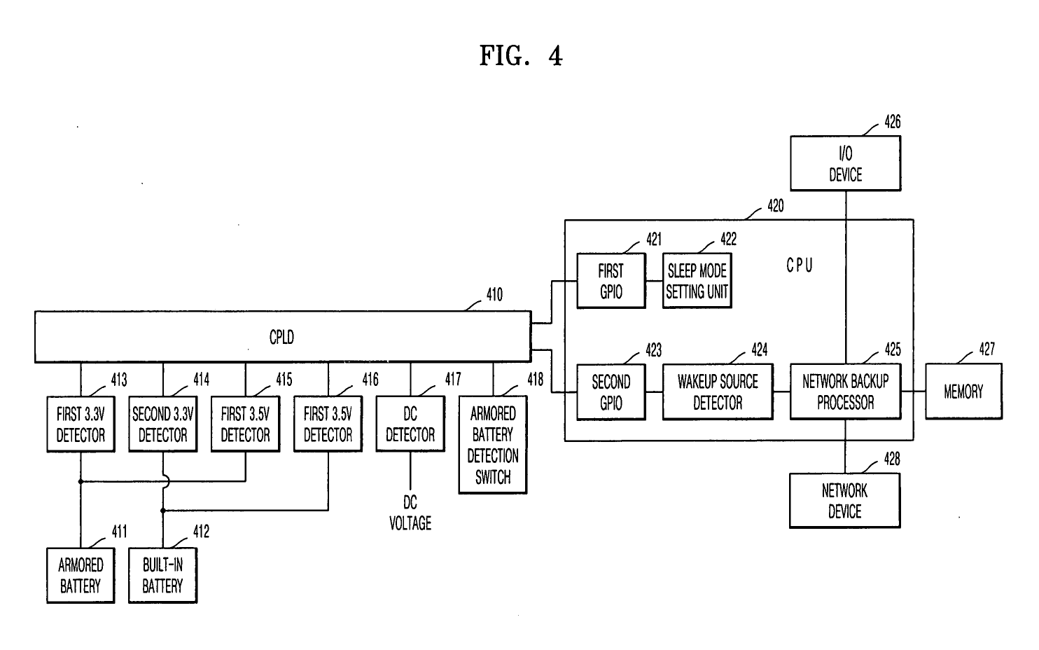

FIG. 4 is a block diagram illustrating an apparatus for managing power of the portable information device, according to the present invention.

Referring to FIG. 4, the apparatus includes a CPLD 410 that detects battery power and generates an interrupt signal, and a CPU 420 that enters the suspended state 340 or performs data backup in response to the interrupt signal.

The CPLD 410 is coupled with a first 3.3V detector 413 that detects whether the voltage of an armored battery 411 drops below 3.3V, a second 3.3V detector 414 that detects whether the voltage of a built-in battery 412 drops below 3.3V, a first 3.5V detector 415 that detects whether the voltage of the armored battery 411 drops below 3.5V, a second 3.5V detector 416 that detects whether the voltage of the built-in battery 412 drops below 3.5V, a DC detector 417 that detects DC voltage, and a detection switch 418 that detects whether the armored battery 411 is loaded.

The CPLD 410 is also coupled with a first general purpose input/output (GPIO) 421 of the CPU 420, in order to inform the CPU 420 of a power failure when the voltages of either the armored battery 411 or the built-in battery 412 drop below 3.5V and allow the CPU 420 to proceed to a sleep mode—i.e. the suspended state 340. The CPLD 410 is also coupled through a backup line with a second GPIO 423 of the CPU 420, in order to wake up the CPU 420 out of the sleep mode to backup user data stored in a memory 427 to a server on a network, when the battery voltage drops below 3.3V.

The CPU 420 includes the first and second GPIOs 421 and 423, a sleep mode setting unit 422, a wakeup source detector 424, and a network backup processor 425, and is coupled with an I/O device 426, a memory 427, and a network device 428.

The first GPIO 421 receives the interrupt signal from the CPLD 410, which indicates that the battery voltage has dropped below 3.5V, and then provides a control signal to the sleep mode setting unit 422.

The sleep mode setting unit 422 sets the device to a low power consumption state in response to the control signal received from the first GPIO 421.

The second GPIO 423 receives a predetermined wakeup signal from the CPLD 410. The wakeup signal includes a control signal that indicates the battery voltage has dropped below 3.3V, as well as other control signals generated by user manipulation.

The wakeup source detector 424 receives the control signal from the second GPIO 423, detects which source sent the control signal, and then provides a control signal to a corresponding functional unit (not shown) to perform an action that corresponds to the detected source. In particular, the wakeup source detector 424 provides a control signal to the network backup processor 425 to perform the data backup over the network if it receives the control signal from the CPLD 410 indicating the battery voltage had dropped below 3.3V.

The network backup processor 425 receives the control signal from the wakeup source detector 424 and then backs up data stored in the internal memory 427 into a server through a network device 428. Here, the network backup processor 425 sends the data stored in the internal memory 427 across the network by HTTP or FTTP to a server user selected in advance.

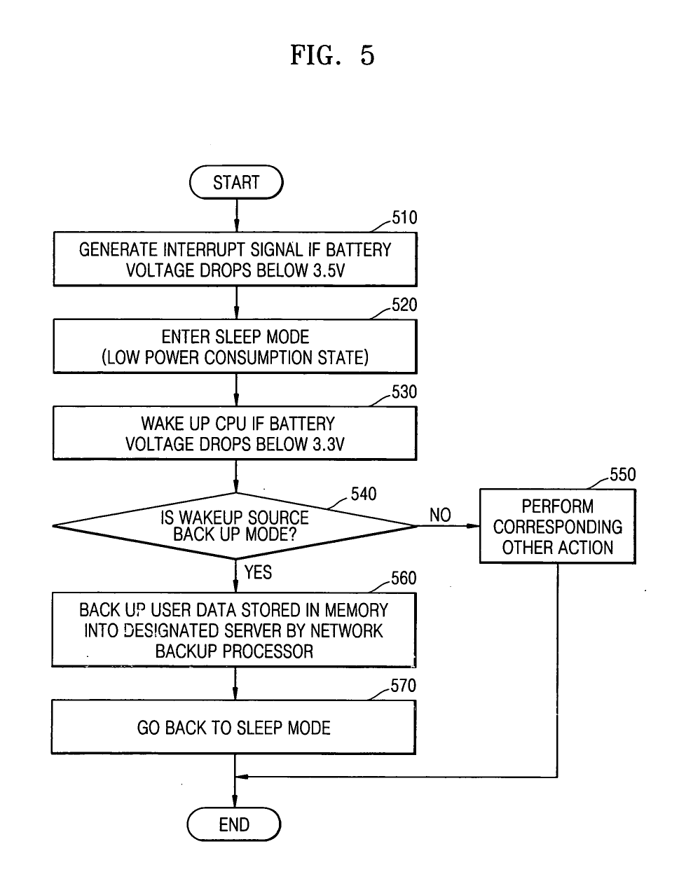

FIG. 5 is a flowchart illustrating a method of managing power in a portable information device, according to the present invention.

Referring to FIG. 5, the interrupt signal is generated when the battery voltage drops below 3.5V, in operation 510.

The device goes into the sleep mode, i.e., the low power consumption suspended state 340, in operation 520. The device continues consuming power in the low power consumption state, unless the user recharges the battery.

If the battery voltage drops below 3.3V, the CPLD 410 sends a wakeup signal to the second GPIO 423 through the backup line to wake up the CPU 420, in operation 530.

It is determined whether a wakeup source is to be backup in operation 420. That is, it is determined whether the wakeup signal includes a control signal that indicates that the battery voltage has dropped below 3.3V.

If the wakeup source is not slated for backup, other corresponding action is performed in operation 550.

If the wakeup source is slated for backup, the network backup processor 425 accesses the designated server, starts a FTTP or HTTP session, and stores user data from the memory 427 in the server, in operation 560.

After finishing the data backup, the device enters the sleep mode again in operation 570.

In the above described embodiment of the present invention, the first threshold voltage for entering the sleep mode is 3.5V and the second threshold voltage for backing up data across the network is 3.3V. However, these threshold voltages are only examples and actual threshold voltages can vary. In the present invention, data backup over the network is performed when the power supply of the portable information device drops below the minimum power necessary to sustain the typical low power consumption state.

According to the present invention, as described above, two threshold voltages are set. If the power of a battery of a portable information device drops below a first threshold voltage, the device is reconfigured to reduce power consumption by switching itself into a low power consumption state. In the low power consumption state, if a user recharges the battery, the device can be recovered to a normal operating state quickly. If the power of the battery drops below a second threshold voltage, which is less than the first threshold voltage, the device backs up data stored in a memory of the device through a network, thereby preserving the data even if the battery completely runs out. Thus, with two thresholds, the present invention can provide flexible power management in the portable information device.

It is possible for the method of managing power in a portable information device according to the present invention to be implemented as a computer program. Codes and code segments constituting the computer program may readily be inferred by those skilled in the art. The computer programs may be recorded on computer-readable media and read and executed by computers. Such computer-readable media include all kinds of storage devices, such as ROM, RAM, CD-ROM, magnetic tape, floppy disc, optical data storage devices, etc. The computer-readable media also include everything that is realized in the form of carrier waves, e.g., transmission over the Internet. The computer-readable media may be distributed to computer systems connected to a network, and codes on the distributed computer-readable media may be stored and executed in a decentralized fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of managing power in a portable information device, the method comprising:
entering a low power consumption state if power of the device drops below a first threshold; and
backing up data stored in an internal memory of the device through a network if the power of the device drops below a second threshold that is lower than the first threshold.

2. The method of claim 1, further comprising:
re-entering the low power consumption state after the backup.

3. The method of claim 1, further comprising:
backing up data stored in the internal memory of the device into an external memory.

4. An apparatus for managing power in a portable information device, the apparatus comprising:
a backup processor that launches the device into a low power consumption state if power of the device drops below a first threshold, and backs up data stored in an internal memory of the device through a network if the power of the device drops below a second threshold that is less than the first threshold.

5. The apparatus of claim 1, wherein the backup processor launches the device back into the low power consumption state after the backup.

6. The apparatus of claim 4, wherein the backup processor backs up the data stored in the internal memory into an external memory.

7. An apparatus for managing power of a portable information device that stores user data in a memory, the portable information device having an armored battery and a built-in battery, the apparatus comprising:
a complex programmable logic device (CPLD) that detects battery power and generates an interrupt signal; and
a central processing unit (CPU) that enters a suspended state or performs data backup in response to the interrupt signal.

8. The apparatus of claim 7, further comprising:
a first threshold voltage detector coupled to the CPLD that detects whether the voltage of the armored battery or the built-in battery drops below a first threshold value; and
a second threshold voltage detector that detects whether the voltage of the armored battery or the built-in battery drops below the second threshold value.

9. The apparatus of claim 8, wherein the first threshold value is lower than the second threshold value.

10. The apparatus of claim 8, wherein the first threshold value is 3.3 volts.

11. The apparatus of claim 8, wherein the second threshold value is 3.5 volts.

12. The apparatus of claim 8, wherein the CPU comprises:
a first general purpose input output device (GPIO);
a second GPIO;
a sleep mode setting unit;
a wakeup source detector; and
a network backup processor,
wherein the first general purpose input/output (GPIO) is coupled to the CPLD to inform the CPU of a power failure when the voltages of either the armored battery or the built-in battery drop below the second threshold value and allow the CPU to proceed to a sleep mode, and the second GPIO coupled to the CPLD through a backup line of the CPU to wake up the CPU out of the sleep mode to backup user data stored in the memory to a server on a network when the battery voltage drops below the first threshold value.

13. The apparatus of claim 12, wherein the first GPIO receives the interrupt signal from the CPLD, which indicates that the battery voltage has dropped below the second threshold value, and then provides a control signal to the sleep mode setting unit.

14. The apparatus of claim 13, wherein the sleep mode setting unit sets the device to a low power consumption state in response to the control signal received from the first GPIO.

15. The apparatus of claim 12, wherein the second GPIO receives a predetermined wakeup signal from the CPLD, the wakeup signal including a control signal that indicates the battery voltage has dropped below a first threshold value.

16. The apparatus of claim 15, wherein the wakeup source detector receives the control signal from the second GPIO, detects which source sent the control signal, and then provides a control signal to the network backup processor.

17. The apparatus of claim 16, wherein the network backup processor receives the control signal from the wakeup source detector and then backs up data stored in the internal memory into a server through a network device.
